(19) United States
(12) Patent Application Publication
(10) Pub. No.: US 2026/0327751 A1
(43) Pub. Date: Oct. 22, 2026

(54) METHODS FOR PROCESSING LOW TEMPERATURE MULTIPHASE ALLOYS

(71) Applicant: UCHICAGO ARGONNE, LLC, Chicago, IL (US)

(72) Inventors: William L. Ebert, Batavia, IL (US); Vineeth Kumar Gattu, Chicago, IL (US); J. Ernesto Indacochea, Glenview, IL (US)

(21) Appl. No.: 19/543,526

(22) Filed: Feb. 18, 2026

Related U.S. Application Data
(60) Provisional application No. 63/791,220, filed on Apr. 18, 2025.

(51) Int. Cl. C22C 1/03; C22C 16/00; C22C 38/00; C22C 38/14; G21F 9/30

(52) U.S. Cl. CPC C22C 1/03; C22C 16/00; C22C 38/005; C22C 38/14; G21F 9/302

(57) ABSTRACT

Provided are methods of forming alloys comprising admixing a metal source comprising refractory metals with a eutectic mixture (first admixture), heating the first admixture to a first processing temperature of at least a melting temperature of the eutectic mixture, and at least 100° C. less than the melting temperature of a eutectic alloy, to dissolve the refractory metals in the eutectic mixture thereby forming a molten intermediate, admixing the molten intermediate with the eutectic alloy (second admixture), heating the second admixture to a second processing temperature of at least a melting temperature of the eutectic alloy, and less than a melting temperature of the refractory metals, wherein the first molten intermediate and the molten second eutectic alloy form the alloy (molten), and cooling the alloy, to provide the alloy, wherein phases comprising the refractory metals distributed therein are formed, where the eutectic mixture and eutectic alloy each comprise iron and zirconium.

### CROSS-REFERENCE TO RELATED APPLICATIONS

The benefit of priority of U.S. Provisional Application 63/791,220 filed on Apr. 18, 2025 is hereby claimed and the disclosure thereof is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates generally to methods of making multiphase alloys. More particularly, the disclosure relates to methods of producing alloys from refractory metals and eutectic mixtures of zirconium and iron.

### BACKGROUND

A metal matrix composite (MMC) is a composite material with fibers or particles of ceramic (such as alumina or silicon carbide), or another metal (such as steel) dispersed in a metallic matrix. MMCs are useful because they can exhibit higher strength-to-weight ratios, stiffness, and ductility as compared to traditional materials. As a result, MMCs are often used in applications with harsh conditions, such as piston liners in automobile engines. However, MMCs generally have electrical and chemical properties which may be equivalent but are often worse than non-composite materials. As a result, it is desirable to develop MMCs which are durable to harsh environmental conditions while retaining the beneficial properties of MMCs.

Additionally, MMCs are generally more expensive than the traditional or conventional composites or alloys. As a result, MMCs are typically only used in applications where the improvement in properties and performance can outweigh the higher cost. Currently, the high manufacturing costs associated with MMCs have narrowed their use to niche applications such as aircraft components, aerospace components and high-end sports equipment. Yet, as manufacturing costs are reduced, the scope of applications of MMCs will be increased.

In recent years, the performance of a class of metallic materials known as high entropy alloys (HEAs) has attracted significant interest. Certain types of these metallic alloys, particularly those comprising multiple elements and forming complex multiphase microstructures, exhibit unique physical properties such as high resistance to corrosion-when compared to traditional alloys. As a result, these corrosion resistant alloys (CRAs) show promise for use in harsh environments. However, the broader category of multiphase alloys is not yet widely adopted in specialty or consumer products, in part due to challenges in precisely defining their compositions and achieving reproducible preparation, especially on an industrial scale.

### SUMMARY

Methods in accordance with the disclosure can be used to prepare multi-phase alloys using lower temperatures than traditional methods. The methods of the disclosure can also be used to prepare multi-phase alloys with desired properties based on the addition of one or more additives and/or one or more additional metals.

A method of forming an alloy in accordance with the disclosure can include: admixing a metal source comprising one or more refractory metals with a first eutectic mixture to form a first admixture, heating the first admixture to a first processing temperature that is at least a melting temperature of the first eutectic mixture to thereby melt the first eutectic mixture and dissolve the metal source in the first eutectic mixture thereby forming a first molten intermediate, admixing the first molten intermediate with a second eutectic alloy, heating the admixture of the first molten intermediate and the second eutectic alloy to a second processing temperature that is at least a melting temperature of the second eutectic alloy to thereby melt the second eutectic alloy, wherein the first molten intermediate and the molten second eutectic alloy mix to form the alloy in molten form, and cooling the alloy in molten form to thereby produce the alloy, wherein upon cooling of the alloy in molten form, one or more phases comprising the one or more refractory metals distributed therein are formed, where the first eutectic mixture and second eutectic alloy each comprise iron and zirconium, the melting temperature of the first eutectic mixture is at least 100° C. less than the melting temperature of the second eutectic alloy, the first processing temperature is less than the second processing temperature, and the second processing temperature is less than a melting temperature of the one or more refractory metals.

A method of forming an alloy in accordance with the disclosure can include: admixing a metal source comprising one or more refractory metals with a first eutectic mixture and a second eutectic alloy, heating the admixture to a first processing temperature that is at least a melting temperature of the first eutectic mixture and less than a melting temperature of the second eutectic alloy, to thereby melt the first eutectic mixture and dissolve the metal source in the first eutectic mixture thereby forming a first molten intermediate, wherein the second eutectic alloy remains in a solid form, and heating the first molten intermediate and solid second eutectic alloy to a second processing temperature that is at least a melting temperature of the second eutectic mixture to thereby melt the second eutectic alloy, wherein the first molten intermediate and the molten second eutectic alloy mix to form a molten alloy, and cooling the molten alloy to thereby produce the alloy, wherein upon cooling of the molten alloy, one or more phases comprising the one or more refractory metals distributed therein are formed, where the first eutectic mixture and second eutectic alloy each comprise iron and zirconium, the melting temperature of the first eutectic mixture is at least 100° C. less than the melting temperature of the second eutectic alloy, the first processing temperature is less than the second processing temperature, and the second processing temperature is less than a melting temperature of the one or more refractory metals.

Further provided herein is a method for processing waste nuclear material for safe handling, comprising preparing a waste metal alloy from a waste nuclear material source and can include admixing the waste nuclear material source comprising uranium and a cladding comprising zirconium with a first eutectic mixture and a second eutectic alloy, heating the admixture to a first processing temperature that is at least the melting temperature of the first eutectic mixture to thereby melt the first eutectic mixture and dissolve the waste nuclear material source in the first eutectic mixture, wherein the second eutectic alloy remains in a solid form, thereby forming a first molten intermediate having the solid second eutectic alloy therein, heating the first molten intermediate having the solid second eutectic alloy therein to a second processing temperature that is at least the melting temperature of the second eutectic alloy to melt the second eutectic alloy, wherein the first molten intermediate and the molten second eutectic alloy mix to form a molten waste alloy, and cooling the molten waste metal alloy of the molten alloy, one or more phases comprising the waste nuclear material source distributed therein are formed to thereby produce the waste metal alloy for safe handling and/or disposal, where the first eutectic mixture and the second eutectic alloy each comprises iron and zirconium, the melting temperature of the first eutectic mixture is at least 100° C. less than the melting temperature of the second eutectic alloy, the first processing temperature is less than the second processing temperature, and the second processing temperature is less than a melting temperature of the waste nuclear metal source.

### BRIEF DESCRIPTION OF THE DRAWINGS

FIG. 1 is a schematic showing the temperatures used in methods of the disclosure.

FIG. 2 is a phase diagram for iron and zirconium.

FIG. 3 is a schematic showing the steps used in accordance with methods of the disclosure.

FIG. 4 is an image of the 316L stainless steel bar after processing.

FIG. 5 is a schematic showing zirconium rods immersed in the first eutectic mixture.

FIG. 6 is an image of the zirconium rods immersed in the first eutectic mixture.

FIG. 7A is a top-down image of the zirconium rods in the first eutectic mixture after heating to 1175° C. for 2 hours.

FIG. 7B is a bottom-up image of the zirconium rods in the first eutectic mixture after heating to 1175° C. for 2 hours.

FIG. 8 is a cross-section image of the zirconium rods in the first eutectic mixture after heating to 1175° C. for 2 hours.

FIG. 9 is a SEM micrograph of the first eutectic mixture after heating to 1175° C. for 2 hours and then cooling.

FIG. 10 is a phase diagram for iron and zirconium with the compositions of the first eutectic before and after dissolution of the zirconium rods circled.

FIG. 11 is a SEM micrograph of a multiphase alloy waste form prepared in a muffle furnace at 1650° C.

FIG. 12 is a SEM micrograph of a MMC multiphase alloy prepared in a muffle furnace at 1250° C.

FIG. 13 is a phase diagram for iron and zirconium with uranium-containing phases indicated.

FIG. 14 is a SEM micrograph of an ingot of multiphase alloy waste form prepared in accordance with the disclosure.

### DETAILED DESCRIPTION

Provided herein are methods for preparing single phase alloys and multiphase alloys from metal sources using a first eutectic mixture and a second eutectic alloy that advantageously allows for processing temperatures that are lower than required when making such alloys from conventionally casting methods and with improved control over the metal distribution and resulting microstructure of the alloys produced. Embodiments of the methods of the disclosure can be useful in preparing metal alloys from nuclear waste material in order to provide for safe handling and/or disposal of the nuclear waste material.

The methods of forming an alloy in accordance with the disclosure can include admixing a metal source including one or more refractory metals with a first eutectic mixture to form a first admixture. In some embodiments of the method, the first admixture further includes a second eutectic alloy. In other embodiments, the second eutectic alloy is added after the first admixture (without the second eutectic alloy) is melted. The method further includes heating the first admixture to a first processing temperature that is at least a melting temperature of the first eutectic mixture to thereby melt the first eutectic mixture and dissolve the metal source in the first eutectic mixture thereby forming a first molten intermediate. As noted above, in embodiments in which the first admixture does not include the second eutectic alloy, the method further includes admixing the first molten intermediate with the second eutectic alloy and heating the admixture of the first molten intermediate and the second eutectic alloy to a second processing temperature that is at least a melting temperature of the second eutectic alloy. In embodiments in which the first admixture includes both the first eutectic mixture and the second eutectic alloy, the method includes heating the first molten intermediate, which includes the second eutectic alloy in solid form, to the second processing temperature. By heating to the second processing temperature, the second eutectic alloy is melted and combines with the first molten intermediate, resulting in the formation of a molten alloy. As the desired molten alloy is formed, the relative amounts of the first eutectic mixture and the second eutectic alloy in the molten alloy change. Additionally, as the relative amounts of the first eutectic mixture and the second eutectic alloy change, the one or more refractory metals are distributed into the molten alloy. Then, upon cooling one or more phases form in the alloy, where the one or more refractory metals are incorporated homogenously into specific phases of the desired alloy. In methods of the disclosure, the first eutectic mixture and second eutectic alloy each include iron and zirconium. The melting temperature of the first eutectic mixture is at least 100° C. less than the melting temperature of the second eutectic alloy. The first processing temperature is less than the second processing temperature, such that when the second eutectic alloy is present in the first admixture, heating to the first processing temperature does not result in melting of the second eutectic alloy and it remains in a solid form. Advantageously, the method of the disclosure allows for processing of the metal source at temperatures less than the melting temperature of the metal source. As such, the second processing temperature is less than a melting temperature of the one or more constituent metals, which typically include refractory metals.

Traditional refractory metals typically require processing at very high temperatures due to the high melting points of the refractory metals used. The methods of the disclosure can form high temperature alloys at lower temperatures than the refractory metal melting temperatures and be used to form solid metal alloy structures through casting methods. Further, the methods of the disclosure can serve as an alternative or enhancement to traditional 3D printing techniques. For example, adding the first eutectic mixture to a refractory metal powder, such as tungsten, can achieve lower processing temperatures and better homogeneity in the phases of the 3D printed material. Moreover, the first eutectic mixture and refractory metal powder can be mixed to provide alternative layers of the first eutectic mixture and refractory metal powder. In these cases, the alloying is expected to occur uniformly when the assemblage is heated.

A eutectic system is a homogenous, solid mixture of two or more substances, typically metals, that form a lattice or extended structure and melts or solidifies at a lower temperature than its constituent materials. Owning to their relatively lower melting temperature and other properties, eutectic mixtures are commonly used in diverse applications such as soldering, brazing, metal casting, electrical protection, fire sprinkler systems, and nontoxic mercury substitutes. Methods of the disclosure advantageously utilize a eutectic mixture of iron and zirconium in a first heating step and a eutectic alloy at a second heating step to allow for the lower temperature processing of the metal source. The first eutectic mixture can dissolve the one or more refractory metals of the metal source and does not result in any precipitate formation after dissolving the one or more refractory metals of the metal source. The second eutectic alloy, when molten, can mix with the molten first intermediate to affect the composition of the molten alloy. As the molten second eutectic alloy mixes with the first molten intermediate to form the molten alloy, the different concentration of metals of the first molten intermediate and molten second eutectic alloy change the composition of the molten alloy. Upon cooling of the molten alloy, the one or more refractory metals are distributed to distinct homogenous phases of the prepared alloy by diffusion and convection.

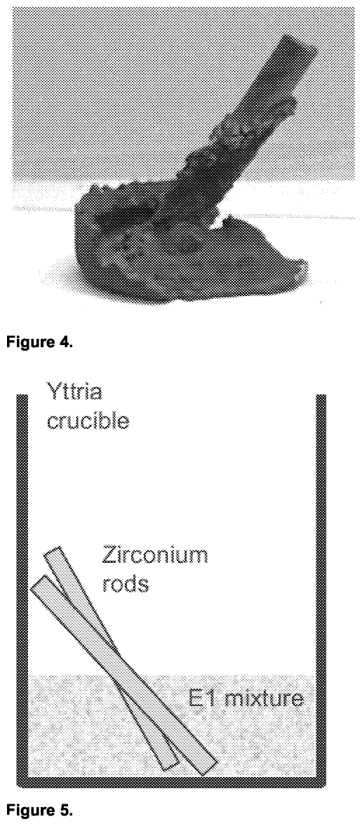

The method of the disclosure also provide control over the composition of the prepared alloy. As the second eutectic alloy only mixes with the first molten intermediate when the second eutectic alloy is molten, the second processing temperature can be used to control the composition of the molten alloy. Upon cooling of the molten alloy, distinct phases form in the cooled alloy where each phase has a uniform composition. Moreover, the one or more refractory metals are incorporated as the distinct phases form in the cooling alloy. As a result, the alloy provided has a microstructure with distinct phases that are each homogeneous in composition. For example, as shown in FIG. 4 steel did not dissolve in the molten first eutectic mixture at the first temperature, while FIG. 12 showed that the molten second eutectic alloy dissolved in the first molten intermediate at the second processing temperature to generate ZrFe₂ intermetallic (lighter phase) and ferrite (alpha-Fe) (darker phase). Thus, the zirconium was incorporated into the ZrFe₂ phases of the alloy, while the remaining iron formed ferrite. As a result, the melting temperature of the second eutectic alloy can be used to control when the metals of the second eutectic alloy are dissolved in the molten alloy and when the alloy phases precipitate.

Additionally, the methods of the disclosure provide enhanced control over the prepared alloy and can be used to tailor the prepared alloy as desired. In accordance with methods of the disclosure, the microstructure of the prepared alloy can be controlled, for example, through one or both of the selection of the metal source and inclusion of one or more additives in the first eutectic mixture and/or the second eutectic alloy. It was observed that the methods of the disclosure also provide an alloy with a microstructure in which the composition of each phase present is more homogeneous than traditionally prepared multi-phase alloys.

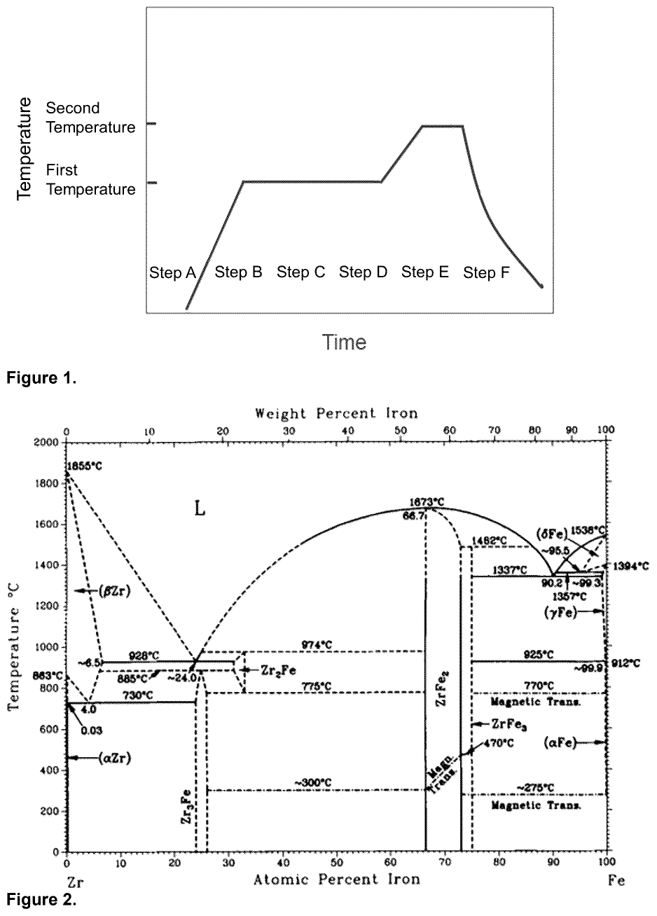

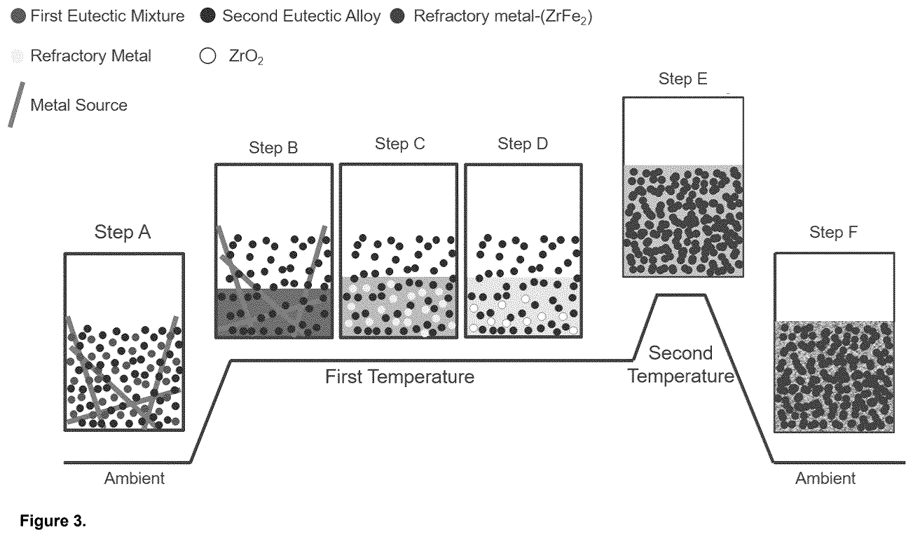

As shown schematically in FIG. 1, the metal source and the first eutectic mixture can be combined at ambient temperature to form an admixture (Step A). The admixture can also include the second eutectic alloy (as illustrated in FIG. 3), which is in solid form, or the second eutectic alloy can be added in a step following the first heating step (prior to Step E, as shown in FIG. 1). The admixture can be heated in a first heating step to the first temperature (Step B) and maintained for a hold time to form the first molten intermediate (Step C). The metal source can optionally include one or more metal oxides. The metal oxides can be reduced, either in part or completely, by the molten first eutectic mixture by holding the first temperature for an extended period of time (Step D). After, the first molten intermediate and second eutectic alloy can be heated in a second heating step to the second temperature and maintained for a hold time (Step E) to melt the second eutectic alloy and form the molten alloy. Lastly, the molten alloy can be cooled to form one or more distinct phases comprising the one or more refractory metals distributed therein and provide the alloy. Moreover, the molten alloy can be cooled in desired shapes, such as, for example, through casting methods, or generally cooled in the container in which it is formed, such as when forming waste alloys for safe processing and handling (Step F).

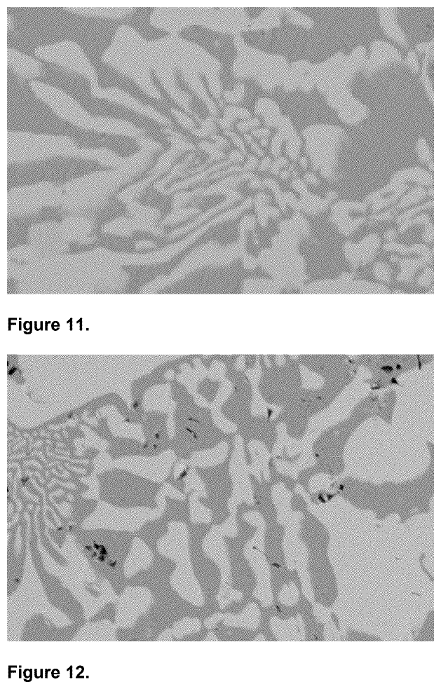

The first and second temperatures can be selected based on the compositions of the metal source, the first eutectic mixture and the second eutectic alloy. As shown in FIG. 2, the phase diagram for the iron-zirconium system exhibits two inflection points, at about 17 wt. % iron and above about 928° C., which is associated with the first eutectic mixture, and at about 85 wt. % iron and above about 1337° C., which is associated with the second eutectic alloy. Accordingly, the first eutectic mixture is melted by heating to the first temperature which can range from 1000° C. to 1300° C., while the second eutectic alloy is melted by heating to the second temperature which is greater than 1300° C. and can be less than the melting temperature of the metal source. However, the second temperature is not particularly limited by the melting temperature of the metal source. Rather, the methods of the disclosure can advantageously provide alloys from metal sources using temperatures below the melting temperature of the metal source and uniformly incorporate the one or more refractory metals throughout the microstructure of the prepared alloy. Consequently, the methods of the disclosure can provide multi-phase alloys where the composition of each phase in the alloy is homogeneous using lower temperatures than required for traditional methods. For instance, a multi-phase alloy prepared in accordance with the method of the disclosure exhibited different phases represented by light and dark shading, where each phase was homogeneous (FIG. 11).

Methods in accordance with the disclosure for preparing a waste metal alloy from a waste nuclear material source for processing waste nuclear material for safe handling can utilize the process as outlined above, for example, as shown in FIGS. 1 and 3. The metal source can be a waste nuclear material source that contains uranium and a cladding that contains zirconium or is zirconium based. The method of preparing a waste metal alloy can include mixing the waste metal source with a first eutectic mixture and then performing a first heating step (FIG. 1) or admixing the waste metal source with a first eutectic mixture and a second eutectic alloy and then performing the first heating step (FIG. 3).

In any of the embodiments of the method, the process can be performed with the admixture being provided in any suitable container that can withstand the heating condition. For example, the container can be formed of stainless steel, for example SS304, carbon steel, or a ceramic material. In embodiments of processing a waste alloy for disposal, the container can be selected for disposal with the waste alloy. For example, the waste alloy formed in the molten state, can be cooled in the container and the waste alloy with the container can be stored or otherwise disposed of.

The methods of the disclosure can also be used to process or prepare composite materials that include a metal matrix with ceramics dispersed throughout. In accordance with the methods of the disclosure, the ceramic can be an additive which can be added into the process before the first heating step with the first eutectic mixture and the second eutectic alloy, if present, or prior to the second heating step with the second eutectic alloy if added separate from the first eutectic mixture. The ceramic can include any ceramic commonly used in the art. For instance, the ceramic can be a metal oxide such as yttria (Y₂O₃), titania (TiO₂) or zirconia (ZrO₂).

For example, in an embodiment, a waste nuclear material source comprising uranium and a cladding comprising zirconium is admixed with a first eutectic mixture and a second eutectic alloy and heated to 1100° C. for 1 hour for the first heating step, then heated to 1300° C. for 1 hour for the second heating step and cooled to provide a waste metal alloy.

### Metal Source

The metal source can be any refractory metal. For example, the metal source can include one or more refractory metals. In some cases, the one or more refractory metals comprise one or more of molybdenum, tungsten, niobium, tantalum, rhenium, ruthenium, osmium, iridium, hafnium, technetium, rhodium, vanadium, chromium, palladium, titanium, and zirconium. In some cases, the one or more refractory metals comprise one or more of molybdenum, tungsten, ruthenium, hafnium, technetium, rhodium, palladium, titanium, and zirconium. In some cases, at least one of the one or more refractory metals are present in the metal source as a metal alloy. In some cases, the metal source can include one or more refractory metals.

The constituent metals of the metal source can affect the relative amounts of the eutectic that are needed to dissolve and distribute the constituent metals into the desired phases. Generally, the relative amounts of metal source and eutectics included in the methods of the disclosure are chosen based on the one or more refractory metals of the metal source. The solubility of the one or more refractory metals of the metal source in the first eutectic mixture is used to determine the relative amounts of metal source and the first eutectic mixture required to dissolve some or all of the metal source. For instance, the phase diagram for iron and zirconium shows that the region near 80 wt. % Zr (right-most circle) will remain liquid as the zirconium content increases up to 86 wt. % (left-most circle). Accordingly, without being bound by theory, it is expected that 1 kg of the first eutectic mixture can accommodate an additional 0.06 kg of zirconium.

As known in the art, the phase diagrams for the metals present in the metal source and the first eutectic mixture can be used to determine the solubility of the one or more metals of the metal source in the first eutectic mixture. In many cases, the relative amounts of metal source and eutectic are selected such that a sufficient amount of eutectic is present to completely dissolve the metal source. For instance, a method in accordance with the disclosure can include a metal source which includes tungsten. Accordingly, the binary phase diagrams for Fe—W, W—Zr, and Fe—Zr would be used. Without being bound by theory, the Fe—W and Fe—Zr phase diagrams suggest that tungsten will dissolve in a Zr—Fe eutectic at temperatures below the Fe-15W eutectic observed in the Fe—W phase diagram.

The metal source can include metal oxides in addition to the one or more refractory metals and can be included as a separate source material or incorporated with the metal source. Accordingly, the metal source can include composite materials. Generally, metal oxides can be incorporated into the alloy provided by methods of the disclosure. At the first temperature, the refractory metals of the metal source (or composite) can be dissolved in the molten first eutectic mixture. As the refractory metals are dissolved, metal oxides present in the metal source (or composite) are contacted by the molten first eutectic mixture and can be chemically reduced to form metals, which are thereby dissolved in the molten first eutectic mixture. As the metal oxides come into contact with the first molten eutectic mixture in order to be chemically reduced, metal oxides can potentially remain incompletely reduced in the first molten intermediate. For instance, the metal oxide can be present in particles. In these cases, the reduction occurs at the outer surface of the metal oxide and penetrates inward. Accordingly, some metal oxide can remain in the product alloy. The remaining metal oxide in the first molten intermediate can be encapsulated by the one or more phases of the molten alloy and therefore, be incorporated uniformly in the distinct phases of the provided alloy without any additional processing. Generally, one or more metals can act as a reductant to reduce some metal oxides present in the molten first eutectic. In embodiments, zirconium, which is present in the molten first eutectic mixture, can act as a reductant to reduce many metal oxides. Without being bound by theory, the thermodynamic capacity of the reductant is sufficient to effectively reduce the metal oxides present. However, as the reductant is consumed, the kinetics of reducing metal oxides can be dependent on temperature and reaction time. Thus, processing temperature and time as well as relative amounts of reductant and oxide can all be varied as desired.

### Additives of the Disclosure

The methods of the disclosure can further comprise admixing one or more additives with the metal source and the first eutectic mixture and/or the second eutectic alloy. Generally, the one or more additives can be based on a variety of factors. The one or more additives can be selected based on the properties desired in the provided alloy. For example, the one or more additives can include one or more ceramics and stainless steel. Stainless steel can be included as an additive to enhance the durability and mechanical strength of the produced alloy. Ceramic materials can be included as additives in order to provide composite alloys.

Generally, the one or more additives can be included in the first eutectic mixture or the second eutectic alloy. The one or more additives added to the metal source and the first eutectic mixture is a mechanical mixture having the eutectic composition that has not been alloyed, while the one or more additives added to the second eutectic alloy is a mixture that has been alloyed.

### First Eutectic Mixture

Generally, the first eutectic mixture can dissolve the one or more refractory metals of the metal source. The first eutectic mixture can be selected such that the dissolution of the one or more refractory metals does not result in any precipitate formation. For example, the first eutectic mixture can include a mixture of iron and zirconium, where the zirconium is present in a higher amount. In some cases, the first eutectic mixture comprises iron in a range of about 10 wt. % to about 30 wt. % and zirconium in a range of about 70 wt. % to about 90 wt. %, based on the total weight of the first eutectic mixture. In some cases, the first eutectic mixture comprises about 20 wt. % Fe and 80 wt. % Zr.

Generally, the first processing temperature, or “first temperature”, is limited based on the melting temperature of the first eutectic mixture. The first temperature can be selected to ensure the first eutectic mixture is molten and to achieve a desired dissolution rate of the metal source in the molten first eutectic. Generally, the dissolution rates of the one or more constituent metals of the metal source can be affected by the temperature as the dissolution rates of a portion of the refractory metals in the metal source may be low at the lower first temperature range, and higher at the upper first temperature range. Additionally, the first temperature is below the melting temperature of the second eutectic alloy to prevent dissolution of the second eutectic alloy into the first eutectic mixture. The melting temperature of the first eutectic mixture can range from about 1000° C. to about 1300° C. Accordingly, the first temperature can generally range from about 950° C. to about 1350° C. In some cases, the first temperature is about 1000° C. to about 1300° C. In some cases, the first temperature is lower than about 1200° C. In some cases, the first temperature is at least 100° C. to about 400° C. less than the second temperature.

### Second Eutectic Alloy

Generally, the second eutectic alloy can assist in forming the one or more phases in the provided alloy and when molten, is soluble in the first molten intermediate. Accordingly, the molten second eutectic alloy can mix with the first molten intermediate to form a molten alloy. As the molten second eutectic alloy mixes with the molten first intermediate, the relative amounts of the iron and zirconium in the molten alloy are modified. In particular, the relative iron content of the molten alloy is increased relative to the first molten intermediate. As the relative iron content increases, distinct phases of iron-zirconium form in the alloy upon cooling. As these distinct phases form in the cooled alloy, the one or more refractory metals, which are present in the first molten intermediate, are incorporated into the newly formed phases of the cooled alloy. Accordingly, the second eutectic alloy is selected to have a melting temperature greater than the first eutectic mixture in order to enable control over the dissolution of the second eutectic alloy, and therefore formation of the distinct one or more phases upon cooling. Additionally, the optionally present metal oxides of the metal source remaining after the first heating step can also be dispersed into the molten alloy and subsequently, into the distinct phases of the cooled alloy.

In some cases, the second eutectic alloy comprises iron in a range of about 80 wt. % to about 90 wt. % and zirconium in a range of about 10 wt. % to about 20 wt. %, based on the total weight of the second eutectic mixture. In some cases, the second eutectic alloy comprises about 85 wt. % Fe and 15 wt. % Zr. In some cases, the second eutectic alloy comprises stainless steel. In some cases, the stainless steel of the second eutectic alloy comprises SS316.

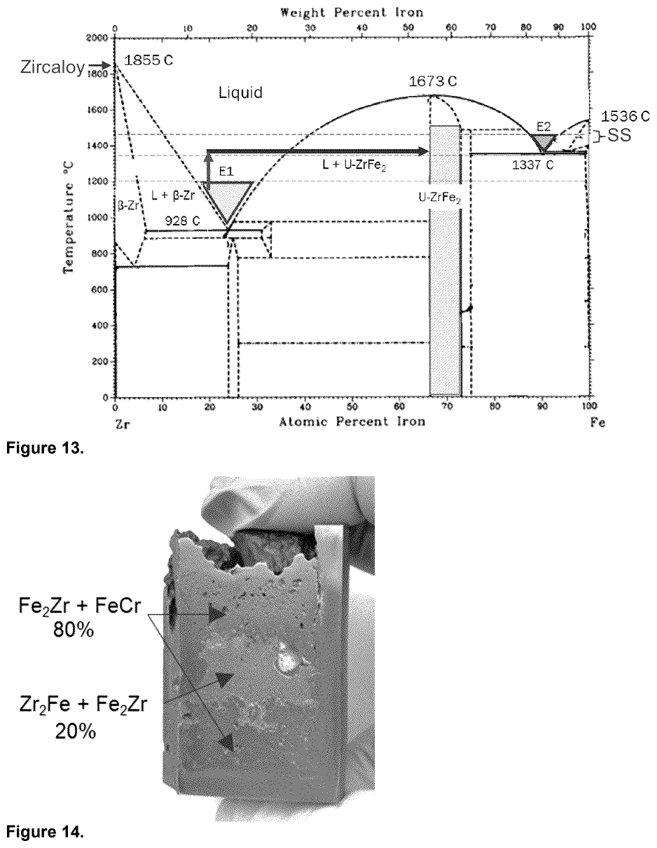

The second processing temperature, or “second temperature”, can be any temperature above the melting temperature of the second eutectic alloy and does not have an upper limit. As the second eutectic alloy is molten at the second temperature, its dissolution can influence the relative amounts of distinct phases that form in the cooled alloy. As such, the second temperature can be selected to generate the molten alloy. For example, FIG. 13 shows that the iron content of the molten first eutectic (E1) after dissolution of zirconium cladding increases from about 14% to about 25 wt. %. Without being bound by theory, this is believed to be due to dissolution of the second eutectic (E2), and subsequent formation of the molten alloy which occurs at the second temperature. Consequently, precipitation of UZrFe₂ is initiated, and continues as the second eutectic dissolves in the molten first intermediate.

In methods of the disclosure, the melting temperature of the second eutectic alloy can range from about 1200° C. to about 1500° C. For example, the second temperature can be greater than about 1200° C. In some cases, the second temperature is less than a melting temperature of the one or more refractory metals in the metal source to advantageously provide a method of processing the refractory metals at a temperature less than their melting temperature.

The second eutectic alloy can optionally include one or more additional metals. As the molten second eutectic alloy is dissolved into the first molten intermediate, the additives, if present, and one or more additional metals, if present, can be incorporated into the molten alloy, and subsequently, incorporated into the distinct phases formed in the cooled alloy concomitantly with the incorporation of the one or more refractory metals of the metal source a. For instance, additional components such as nickel, rhenium or tantalum, can be added at the first temperature or a different temperature and as a source material or part of an additive. For example, high-Ni steel can be used instead of 316 SS to make an Fe—Zr additive. Further, when present, the additives and/or one or more additional metals can be distributed into one or more phases with the one or more refractory metals or the metal source or distributed into distinct phases based on the selection of the additive and/or one or more additional metals. As known in the art, the phase diagram for the additives and/or one or more additional metals with iron and zirconium can be used to determine the phases that will incorporate the additive and/or one or more additional metals. Accordingly, the one or more phases of the cooled alloy can include one or more phases where the additive, if present, and/or the one or more additional metals, if present, are incorporated with or without the one or more refractory metals. In some cases, the one or more phases of the cooled alloy that incorporate the additive, if present, and/or the one or more additional metals, if present, are the one or more phases of the cooled alloy that incorporate the one or more refractory metals of the metal source. In some cases, the one or more phases of the cooled alloy that incorporate the additive, if present, and/or the one or more additional metals, if present, are not the one or more phases of the second molten intermediate that incorporate the one or more refractory metals of the metal source.

The one or more additional metals can be selected to impart specific properties onto the provided alloy. In some cases, the one or more additional metals comprise depleted uranium and/or one or more refractory metals. In some cases, the one or more additional metals are present in an amount of about 1 wt. % to about 15 wt. % based on the total weight of the second eutectic alloy.

The methods of the disclosure can further comprise holding each of the first and second temperatures independently for about 1 hour to about 4 hours. For example, the hold time can be about 1, about 2, about 3, or about 4 hours, or any values there between or ranges defined by such values. In some cases, the hold time at the first temperature is about 2 hours. In some cases, the hold time at the second temperature is about 2 hours.

### Alloy of the Disclosure

The methods of the disclosure further comprise cooling the second molten intermediate to produce the alloy. Upon cooling, the one or more distinct phases of the second molten intermediate form crystalline structures. As used herein, the term “crystalline structures” refers to microscopic crystals formed in the microstructure of an alloy. Accordingly, the one or more distinct phases of the second molten intermediate form one or more distinct crystalline structures in the alloy formed. As is known in the art, any cooling rate can be used such that the alloy is not exposed to excessive changes in temperature or other harsh conditions which would otherwise compromise the integrity of the formed alloy.

The alloy resulting from the methods of the disclosure can comprise multiple crystalline structures based on the one or more phases present in the second molten intermediate. For instance, the phase diagram for the iron-zirconium system shows that βZr, Zr₃Fe, Zr₂Fe, ZrFe₂, ZrFe₃, δFe, and γFe are potential phases that can form in iron-zirconium systems (FIG. 2). Further, the one or more refractory metals can be distributed to one or more iron phases, zirconium phases, or iron-zirconium phases, such that the prepared alloy includes one or more iron phases, zirconium phases, or iron-zirconium phases which comprise the one or more refractory metals.

Moreover, the use of the first eutectic mixture at the first processing temperature and the second eutectic mixture at the second processing temperature allows for the composition and distribution of the metal source to be finely controlled in the provided alloy. The first eutectic mixture serves to dissolve the one or more refractory metals as well as chemically reduce at least a portion of metal oxides which may also be present in the first molten intermediate. The second eutectic alloy serves to promote the formation of uniform phases in the cooled alloy, thereby uniformly distributing the second eutectic alloy and metal source throughout the microstructure of the provided alloy.

The alloy prepared in accordance with the disclosure can have one or more additives and one or more additional metals present to impart specific properties related to the specific additives and/or additional metals chosen. Accordingly, the methods of the disclosure can also be used to prepare composite materials that comprise one or more refractory metals. Similarly, the second eutectic alloy can include one or more additional metals to impart specific properties onto the provided alloy. For instance, chromium, nickel, and molybdenum can be included in the second eutectic alloy to enhance the durability of the provided alloy.

### Waste Material Sources

As disclosed above, the methods of the disclosure include processing waste nuclear material for safe handling by preparing a waste metal alloy from a waste nuclear material source. Waste nuclear material sources can include cladding removed from commercial spent nuclear fuel rods prior to fuel recycling and cladding hulls recovered from used nuclear fuel recycling operations. In accordance with the method of the disclosure, the waste nuclear material source can further include a cladding. The cladding typically has high durability and thermal resistance and can include aluminum, stainless steel, and/or zirconium metals, or alloys thereof, which are necessary to prevent corrosion of the nuclear material as well as the release of fission products. These properties of the cladding also present challenges for processing waste nuclear material for safe handling as the cladding requires high temperatures i.e., >1800° C., or other harsh conditions in order to be processed. Additionally, unirradiated fuel and scraps generated during fuel production can also be used and can include various radioactively contaminated materials and equipment. Sources also include, for example, containers used to store and transport source materials. However, the methods of the disclosure can advantageously prepare waste metal alloys from a waste nuclear material source and a cladding, using temperatures lower than traditional methods. In some cases, the waste nuclear material source comprises uranium and a cladding comprising zirconium. In some cases, the cladding comprises Zircaloy. In some cases, the cladding comprises stainless steel.

In some cases, the waste nuclear metal alloy produced comprises at least two phases, wherein a first phase comprises a mixture of Fe in a range of about 55 to 60 wt. % and a combination of U and Zr in a range of about 40-45 wt. %, and a second phase comprises a Fe solid solution in a range of about 60-95 wt. %. In some cases, the Fe solid solution is austenite or ferrite.

### Aspects of the Disclosure

Aspect 1. A method of forming an alloy, comprising:
admixing a metal source comprising one or more refractory metals with a first eutectic mixture to form a first admixture;
heating the first admixture to a first processing temperature that is at least a melting temperature of the first eutectic mixture to thereby melt the first eutectic mixture and dissolve the metal source in the first eutectic mixture thereby forming a first molten intermediate;
admixing the first molten intermediate with a second eutectic alloy;
heating the admixture of the first molten intermediate and the second eutectic alloy to a second processing temperature that is at least a melting temperature of the second eutectic alloy to thereby melt the second eutectic alloy, wherein the first molten intermediate and the molten second eutectic alloy mix to form the alloy in molten form; and
cooling the alloy in molten form to thereby produce the alloy, wherein upon cooling of the alloy in molten form, one or more phases comprising the one or more refractory metals distributed therein are formed in the alloy;
wherein:
the first eutectic mixture and second eutectic alloy each comprise iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the one or more refractory metals of the metal source.

Aspect 2. A method of forming an alloy, comprising:
admixing a metal source comprising one or more refractory metals with a first eutectic mixture and a second eutectic alloy;
heating the admixture to a first processing temperature that is at least a melting temperature of the first eutectic mixture and less than a melting temperature of the second eutectic alloy, to thereby melt the first eutectic mixture and dissolve the metal source in the first eutectic mixture thereby forming a first molten intermediate, wherein the second eutectic alloy remains in a solid form; and
heating the first molten intermediate and solid second eutectic alloy to a second processing temperature that is at least a melting temperature of the second eutectic mixture to thereby melt the second eutectic alloy, wherein the first molten intermediate and the molten second eutectic alloy mix to form the alloy in molten form; and
cooling the alloy in molten form to thereby produce the alloy, wherein upon cooling of the alloy in molten form, one or more phases comprising the one or more refractory metals distributed therein are formed;
wherein:
the first eutectic mixture and second eutectic alloy each comprise iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the one or more refractory metals of the metal source.

Aspect 3. The method of any one of the preceding aspects, wherein the one or more refractory metals comprise one or more of molybdenum, tungsten, niobium, tantalum, rhenium, ruthenium, osmium, iridium, hafnium, technetium, rhodium, vanadium, chromium, palladium, titanium, and zirconium.

Aspect 4. The method of aspect 3, wherein at least one of the one or more refractory metals are present in the metal source as a metal or alloy.

Aspect 5. The method of any one of the preceding aspects, further comprising admixing one or more additives with the metal source and the first eutectic mixture.

Aspect 6. The method of aspect 5, wherein the one or more additives comprises one or more ceramics, stainless steel, Inconel, copper, Hastelloy, zirconium, or uranium.

Aspect 7. The method of any one of the preceding aspects, wherein the melting temperature of the first eutectic mixture is about 1000° C. to about 1300° C.

Aspect 8. The method of any one of the preceding aspects, wherein the melting temperature of the second eutectic alloy is about 1200° C. to about 1500° C.

Aspect 9. The method of any one of the preceding aspects, comprising holding at the first processing temperature for about 1 hour to 4 hours.

Aspect 10. The method of any one of the preceding aspects, comprising holding at the second processing temperature for about 1 to 4 hours.

Aspect 11. The method of any one of the preceding aspects, wherein the first eutectic mixture comprises iron in a range of about 10 wt. % to about 30 wt. % and zirconium in a range of about 70 wt. % to about 90 wt. %, based on the total weight of the first eutectic mixture.

Aspect 12. The method of any one of the preceding aspects, wherein the second eutectic alloy comprises iron in a range of about 80 wt. % to about 90 wt. % and zirconium in a range of about 10 wt. % to about 20 wt. %, based on the total weight of the second eutectic mixture.

Aspect 13. The method of any one of the preceding aspects, wherein the second processing temperature is less than a melting temperature of the one or more refractory metals in the metal source.

Aspect 14. The method of any one of the preceding aspects, further comprising casting the alloy into a desired shape.

Aspect 15. A method for processing waste nuclear material for safe handling, comprising preparing a waste metal alloy from a waste nuclear material source comprising:
admixing the waste nuclear material source comprising uranium and a cladding comprising zirconium with a first eutectic mixture and a second eutectic alloy;
heating the admixture to a first processing temperature that is at least the melting temperature of the first eutectic mixture to thereby melt the first eutectic mixture and dissolve the waste nuclear material source in the first eutectic mixture, wherein the second eutectic alloy remains in a solid form, thereby forming a first molten intermediate having the solid second eutectic alloy therein;
heating the first molten intermediate having the solid second eutectic alloy therein to a second processing temperature that is at least the melting temperature of the second eutectic alloy to melt the second eutectic alloy, wherein the first molten intermediate and the molten second eutectic alloy mix to form the waste alloy in molten form; and
cooling the waste metal alloy in molten form, wherein upon cooling of the waste alloy in molten form, one or more phases comprising the waste nuclear material source distributed therein are formed to thereby produce the waste metal alloy for safe handling and/or disposal;

wherein:
the first eutectic mixture and the second eutectic alloy each comprises iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the waste nuclear metal source.

Aspect 16. The method of aspect 15, wherein the waste nuclear metal alloy comprises at least two phases, wherein a first phase comprises a mixture of Fe in a range of about 55 to 60 wt. % and a combination of U and Zr in a range of about 40-45 wt. %, and a second phase comprises a Fe solid solution in a range of about 60-95 wt. %.

Aspect 17. The method of aspect 16, wherein the Fe solid solution is austenite or ferrite.

Aspect 18. The method of any one of aspects 15 to 17, wherein the first eutectic mixture comprises about 20 wt. % Fe and 80 wt. % Zr.

Aspect 19. The method of any one of aspects 15 to 18, wherein the second eutectic alloy comprises about 85 wt. % Fe and 15 wt. % Zr.

Aspect 20. The method of any one of the preceding aspects, wherein the second eutectic alloy comprises stainless steel.

Aspect 21. The method of aspect 20, wherein the stainless steel comprises SS316.

Aspect 22. The method of any one of the proceeding aspects, wherein the second eutectic alloy further comprises one or more additional metals.

Aspect 23. The method of aspect 22, wherein the one or more additional metals comprise depleted uranium and/or one or more refractory metals.

Aspect 24. The method of aspects 22 or 23, wherein the one or more additional metals are present in an amount of about 1 wt. % to about 15 wt. % based on the total weight of the second eutectic alloy.

Aspect 25. The method of any one of the proceeding aspects, wherein the first processing temperature is lower than about 1200° C.

Aspect 26. The method of any one of the proceeding aspects, wherein the hold time at the first processing temperature is about 2 hours.

Aspect 27. The method of any one of the proceeding aspects, wherein the second processing temperature is higher than about 1200° C.

Aspect 28. The method of any one of the proceeding aspects, wherein the hold time at the second processing temperature is about 2 hours.

Aspect 29. The method of any one of the proceeding aspects, wherein the first processing temperature is at least 100° C. to about 400° C. less than the second processing temperature.

Aspect 30. The method of any one of the proceeding aspects, wherein admixing and heating is performed in a container and the container comprises SS304, carbon steel, or ceramic material.

### Examples

The following examples are provided for illustration and are not intended to limit the scope of the invention.

### Materials & Methods

Reagent zirconium, stainless steel, and Zircaloy were used and can be obtained from any chemical supplier.

Resistance furnaces and induction furnaces were used under inert atmosphere. The alloys were prepared and cast in a muffle furnace in a glovebox or fume hood under an inert atmosphere, i.e. argon.

Waste nuclear material sources used in the examples included commercially available cladding material and surrogate nuclear fuel pellets.

### Example 1: Study on Solubility of Stainless Steel and Zirconium in Eutectic Mixture

A crucible made of Y₂O₃ was filled with a granular eutectic mixture (E1) of 80 wt. % zirconium metal and 20 wt. % iron metal. Then, a bar of 316L stainless steel was added and partially submerged in the granular mixture. The crucible was heated and maintained at 1175° C. for 2 h. Then, the crucible was cooled to room temperature and analyzed. Analysis of the cooled product mixture showed that the final composition of the eutectic mixture was not affected. As shown in FIG. 4, the bar of 316L stainless steel remained intact after processing. Accordingly, the 316L stainless steel was not dissolved in the eutectic mixture at 1175° C.

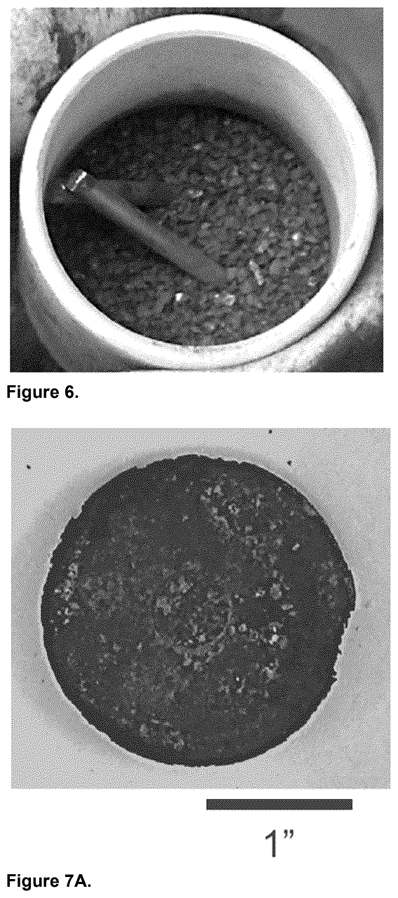

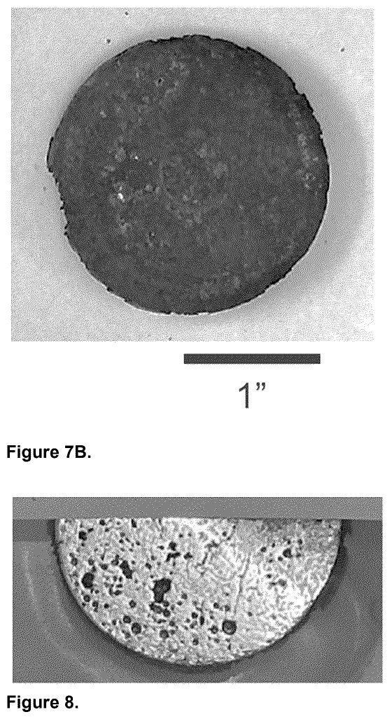

Separately, a Y₂O₃ crucible was filled with a granular eutectic mixture (E1) of 80 wt. % zirconium metal and an amount of stainless steel providing 20 wt. % iron metal. Then, as shown schematically in FIG. 5, a rod of zirconium metal was added and partially submerged in the granular mixture, which is shown in FIG. 6. The crucible was then heated to 1175° C. and maintained for 3 h. After, the crucible was cooled to room temperature and evaluated. As shown in FIGS. 7A and 7B, the zirconium rod was completely dissolved in the E1 eutectic mixture. Thus, contrary to the 316L stainless steel, the zirconium rod was observed to dissolve into the molten eutectic E1 mixture.

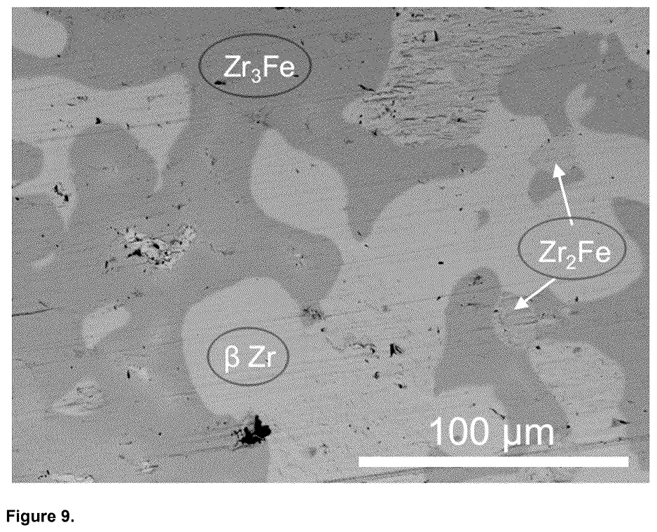

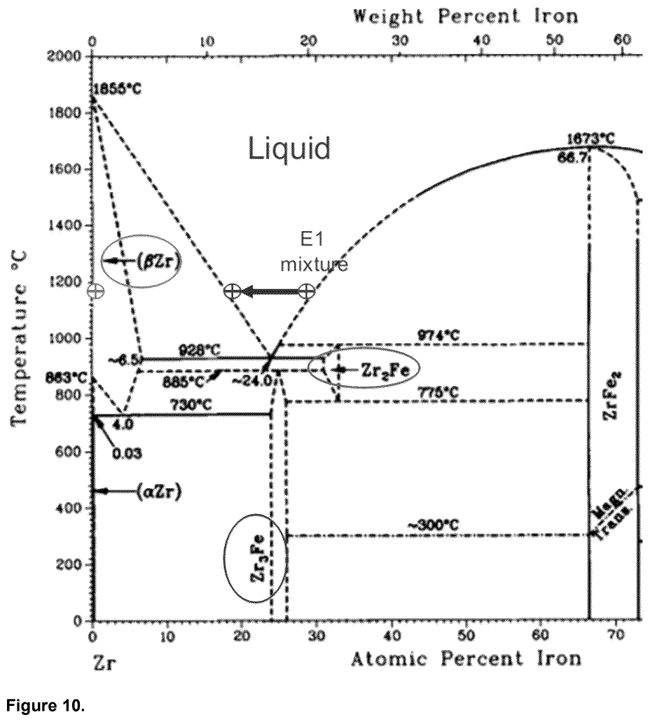

The zirconium/E1 mixture was further investigated by SEM microscopy. A cross section of the zirconium/E1 mixture, as shown in FIG. 8 was analyzed and the SEM micrographs are shown in FIG. 9. The SEM micrographs displayed multiple regions, which correspond to distinct phases of the zirconium-iron mixture with varying amounts of zirconium, including Zr₃Fe, Zr₂Fe and β Zr phases. These phases identified in the cross-section were also identified on the phase-diagram for zirconium-iron, as shown in FIG. 9. Further, the elemental composition of the product mixture revealed that the amount of zirconium had increased from 80 wt. % to 88 wt. %, while the amount of iron in the mixture had decreased to 12 wt. %.

Accordingly, a molten eutectic mixture of 80 wt. % zirconium metal and 20 wt. % iron metal was demonstrated to selectively dissolve zirconium and not iron at 1175° C. Further, the microstructure and elemental composition of the product mixture was analyzed and characterized via SEM imaging and elemental analysis.

### Example 2: Formation and Characterization of Product Alloy

A mixture of zirconium and molten eutectic E1 88 wt. % zirconium metal and 12 wt. % iron metal mixture was prepared as described in Example 2, then mixed with an alloy of Hf and a eutectic mixture (E2) of 85 wt. % Fe and 15 wt. % Zr. This mixture was heated to 1250° C. and maintained for 2 hours.

The microstructure of the alloy prepared at 1250° C. was analyzed and compared to a traditionally prepared multi-phase alloy (“RAW-6”) prepared at 1650° C. As shown in FIG. 11, the alloy prepared in accordance with the disclosure displayed multiple phases. These phases were identified as Fe₂Zr (light shading) and FeCr (dark shading) intermetallic phases. Similarly, the alloy prepared at 1650° C., shown in FIG. 12, exhibited multiple phases which corresponded to the Fe₂Zr (light shading) and FeCr (dark shading) intermetallic phases.

Analysis of the microstructure of the prepared alloy indicated that the prepared alloy was comparable to alloys prepared by traditional methods.

### Comparative Example: Formation of Traditionally Prepared Multi-Phase Alloy (“RAW-6”)

RAW-6 was prepared by melting a mixture of 316L SS and zirconium powder similar to the second eutectic at 1650° C. for three hours then cooling.

### Example 3: Formation and Characterization of Waste Metal Alloy

In a 304 stainless steel crucible, a mixture of waste nuclear material in the form of fuel pellets including uranium, uranium oxide, and zirconium cladding was mixed with a granular eutectic mixture (E1) of 80 wt. % zirconium metal and an amount of stainless steel providing 20 wt. % iron metal and an alloy of Hf and a eutectic mixture (E2) of 85 wt. % Fe and 15 wt. % Zr. The mixture was heated to 1100° C. and maintained for 1 hour, then heated to 1300° C. and maintained for 1 hour, before cooling to room temperature to provide the waste metal alloy.

Analogous to the alloy analyzed in Example 2, the waste metal alloy was observed to have multiple phases (not shown). Further, it was observed that the uranium had formed U—ZrFe₂ phases in the alloy. As shown in FIG. 13, the uranium was dissolved in the E1 eutectic at 1100° C., then upon heating to 1300° C., the uranium was taken into distinct regions of the alloy, the U—ZrFe₂ phase.

Accordingly, a waste metal alloy was prepared in accordance with the methods of the disclosure. Analysis of the microstructure of the prepared alloy indicated that the uranium was present in the U—ZrFe₂ phase.

### Example 4: Larger-Scale Formation and Characterization of Product Alloy

In order to demonstrate processing larger amounts of material, a 1-kg product was produced. In a 304 stainless steel crucible, ten tubes of Zircaloy cladding with different lengths were mixed with pieces of additives according to the E1 composition of 80 wt. % zirconium metal and an amount of stainless steel providing 20 wt. % iron metal and the E2 composition of 85 wt. % Fe and 15 wt. % Zr, described in the above examples. Nine pellets of sintered HfO₂ pellets were placed in two of the Zircaloy tubes to act as surrogate waste nuclear material. The total mass of added reagents was 1 kg. Then, the assembly was placed in a magnesia crucible and heated in a pure argon atmosphere for 4 hours at 1200° C. and then four hours at 1300° C., then allowed to cool in the furnace.

The additives and lower portions of the Zircaloy cladding were alloyed and densified into an ingot; the top portions of some cladding tubes remained protruding from the ingot. The protruding tubes became brittle during processing and were readily broken off.

Similar to Examples 1 and 2, the product alloy was observed to have multiple phases. Cross sections of the ingot were analyzed visually and by using SEM. As shown in FIG. 14, the product was predominantly mixed phase regions with Fe₂Zr and FeCr intermetallic phases similar to that formed in Example 2 (FIG. 11) with a smaller volume of mixed phase regions with Fe₂Zr and Zr₂Fe intermetallic phases similar to that formed in Example 1 (FIG. 9). The microstructure was uniform throughout the ingot.

A fractured HfO₂ pellet revealed in a cross section was microencapsulated by zirconium-rich phases with a detectable extent of reduction. No residual Zircaloy cladding was detected in the ingot, but a small number of tin-rich intermetallics were detected that were probably generated when Zircaloy cladding contacted by the molten metal dissolved. Notably, the grain boundaries of the stainless-steel canister were penetrated by zirconium-enriched molten metal to a depth of a few millimeters during the process, but the integrity of the canister was not affected.

Accordingly, a product alloy was prepared in accordance with the methods of the disclosure. Analysis of the microstructure of the product alloy indicated that the Fe₂Zr and FeCr intermetallic phases predominated.

The term “about” is used according to its ordinary meaning, for example, to mean approximately or around. In one embodiment, the term “about” means [±10% of a stated value or range of values. In another embodiment, the term “about” means±5% of a stated value or range of values. A value or range described in combination with the term “about” expressly includes the specific value and/or range as well (e.g., for a value described as “about 40,” “40” is also expressly contemplated).

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method of forming an alloy, comprising:
admixing a metal source comprising one or more refractory metals with a first eutectic mixture to form a first admixture;
heating the first admixture to a first processing temperature that is at least a melting temperature of the first eutectic mixture to thereby melt the first eutectic mixture and dissolve the metal source in the first eutectic mixture thereby forming a first molten intermediate;
admixing the first molten intermediate with a second eutectic alloy;
heating the admixture of the first molten intermediate and the second eutectic alloy to a second processing temperature that is at least a melting temperature of the second eutectic alloy to thereby melt the second eutectic alloy, wherein the first molten intermediate and the molten second eutectic alloy mix to form the alloy in molten form; and
cooling the alloy in molten form to thereby produce the alloy, wherein upon cooling of the alloy in molten form, one or more phases comprising the one or more refractory metals distributed therein are formed in the alloy;
wherein:
the first eutectic mixture and second eutectic alloy each comprise iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the one or more refractory metals of the metal source.

2. A method of forming an alloy, comprising:
admixing a metal source comprising one or more refractory metals with a first eutectic mixture and a second eutectic alloy;
heating the admixture to a first processing temperature that is at least a melting temperature of the first eutectic mixture and less than a melting temperature of the second eutectic alloy, to thereby melt the first eutectic mixture and dissolve the metal source in the first eutectic mixture thereby forming a first molten intermediate, wherein the second eutectic alloy remains in a solid form; and
heating the first molten intermediate and solid second eutectic alloy to a second processing temperature that is at least a melting temperature of the second eutectic mixture to thereby melt the second eutectic alloy, wherein the first molten intermediate and the molten second eutectic alloy mix to form the alloy in molten form; and
cooling the alloy in molten form to thereby produce the alloy, wherein upon cooling of the alloy in molten form, one or more phases comprising the one or more refractory metals distributed therein are formed;
wherein:
the first eutectic mixture and second eutectic alloy each comprise iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the one or more refractory metals of the metal source.

3. The method of claim 1, wherein the one or more refractory metals comprise one or more of molybdenum, tungsten, niobium, tantalum, rhenium, ruthenium, osmium, iridium, hafnium, technetium, rhodium, vanadium, chromium, palladium, titanium, and zirconium.

4. The method of claim 1, wherein at least one of the one or more refractory metals are present in the metal source as a metal or alloy.

5. The method of claim 1, further comprising admixing one or more additives with the metal source and the first eutectic mixture.

6. The method of claim 5, wherein the one or more additives comprises one or more ceramics, stainless steel, Inconel, copper, Hastelloy, zirconium, or uranium.

7. The method of claim 1, wherein the melting temperature of the first eutectic mixture is about 1000° C. to about 1300° C., and the melting temperature of the second eutectic alloy is about 1200° C. to about 1500° C.

8. The method of claim 1, comprising independently holding at the first processing temperature and/or the second processing temperature for about 1 hour to 4 hours.

9. The method of claim 1, wherein:
the first eutectic mixture comprises iron in a range of about 10 wt. % to about 30 wt. % and zirconium in a range of about 70 wt. % to about 90 wt. %, based on the total weight of the first eutectic mixture; and
the second eutectic alloy comprises iron in a range of about 80 wt. % to about 90 wt. % and zirconium in a range of about 10 wt. % to about 20 wt. %, based on the total weight of the second eutectic mixture.

10. The method of claim 1, wherein the second processing temperature is less than a melting temperature of the one or more refractory metals in the metal source.

11. The method of claim 1, further comprising casting the alloy into a desired shape.

12. A method for processing waste nuclear material for safe handling, comprising preparing a waste metal alloy from a waste nuclear material source comprising:
admixing the waste nuclear material source comprising uranium and a cladding comprising zirconium with a first eutectic mixture and a second eutectic alloy;
heating the admixture to a first processing temperature that is at least the melting temperature of the first eutectic mixture to thereby melt the first eutectic mixture and dissolve the waste nuclear material source in the first eutectic mixture, wherein the second eutectic alloy remains in a solid form, thereby forming a first molten intermediate having the solid second eutectic alloy therein;
heating the first molten intermediate having the solid second eutectic alloy therein to a second processing temperature that is at least the melting temperature of the second eutectic alloy to melt the second eutectic alloy, wherein the first molten intermediate and the molten second eutectic alloy mix to form the waste alloy in molten form; and
cooling the waste metal alloy in molten form, wherein upon cooling of the waste alloy in molten form, one or more phases comprising the waste nuclear material source distributed therein are formed to thereby produce the waste metal alloy for safe handling and/or disposal;
wherein:
the first eutectic mixture and the second eutectic alloy each comprises iron and zirconium;
the melting temperature of the first eutectic mixture is at least 100° C. less than the melting temperature of the second eutectic alloy;
the first processing temperature is less than the second processing temperature; and
the second processing temperature is less than a melting temperature of the waste nuclear metal source.

13. The method of claim 12, wherein the waste nuclear metal alloy comprises at least two phases, wherein a first phase comprises a mixture of Fe in a range of about 55 to 60 wt. % and a combination of U and Zr in a range of about 40-45 wt. %, and a second phase comprises a Fe solid solution in a range of about 60-95 wt. %.

14. The method of claim 12, wherein the Fe solid solution is austenite or ferrite.

15. The method of claim 12, wherein the first eutectic mixture comprises about 20 wt. % Fe and 80 wt. % Zr and the second eutectic alloy comprises about 85 wt. % Fe and 15 wt. % Zr.

16. The method of claim 12, wherein the second eutectic alloy further comprises one or more additional metals.

17. The method of claim 16, wherein the one or more additional metals comprise depleted uranium and/or one or more refractory metals.

18. The method of claim 12, wherein the first processing temperature is lower than about 1200° C. and the second processing temperature is higher than about 1200° C.

19. The method of claim 12, comprising independently holding at the first processing temperature and/or the second processing temperature for about 1 to 4 hours.

20. The method of claim 12, wherein the first processing temperature is at least 100° C. to about 400° C. less than the second processing temperature.
